(19) United States
(12) Patent Application Publication
(10) Pub. No.: US 2026/0175636 A1
(43) Pub. Date: Jun. 25, 2026

(54) AUTOMATIC LIFT-UP CONTROL DEVICE, AUTOMATIC LIFT-UP MANAGEMENT DEVICE, AUTOMATIC LIFT-UP CONTROL SYSTEM, AUTOMATIC LIFT-UP CONTROL METHOD, AUTOMATIC LIFT-UP MANAGEMENT METHOD, AND STORAGE MEDIUM

(71) Applicant: Sony Honda Mobility Inc., Tokyo (JP)

(72) Inventor: Toshihiro Hirao, Tokyo (JP)

(73) Assignee: Sony Honda Mobility Inc., Tokyo (JP)

(21) Appl. No.: 19/077,688

(22) Filed: Mar. 12, 2025

(30) Foreign Application Priority Data
Dec. 25, 2024 (JP) 2024-228557

(51) Int. Cl. B60G 17/0165

(52) U.S. Cl. CPC B60G 17/0165; B60G 2400/10; B60G 2400/252; B60G 2500/30

(57) ABSTRACT

An automatic lift-up control device includes: an acquisition unit which acquires position information indicating a position of a target vehicle and lift-up recommendation point information having a registered recommendation point for recommending lift-up based on information provided from a plurality of vehicles; a determination unit which determines whether or not the position of the target vehicle corresponds to the recommendation point registered in the lift-up recommendation point information; and a lift-up control unit which lifts up the target vehicle when it is determined that the position of the target vehicle corresponds to the recommendation point registered in the lift-up recommendation point information.

### CROSS-REFERENCE TO RELATED APPLICATION

Priority is claimed on Japanese Patent Application No. 2024-228557 filed on Dec. 25, 2024, the content of which is incorporated herein by reference.

### BACKGROUND OF THE INVENTION

### Field of the Invention

The present invention relates to an automatic lift-up control device, an automatic lift-up management device, an automatic lift-up control system, an automatic lift-up control method, an automatic lift-up management method, and a storage medium.

### Description of Related Art

Conventionally, vehicles with height adjustment functions such as air suspension generally had a function to raise the minimum ground clearance (hereinafter, referred to as “lift-up”) in order to reduce the risk of contact with the ground on rough roads such as roads with steps. For example, a vehicle height control device is known that pre-registers points where lift-up is required based on the vehicle's past driving history, and automatically performs lift-up when the vehicle again travels through a point where lift-up is required (see, for example, Patent Documents 1 to 3 below).
[Patent Document 1] Japanese Unexamined Patent Application, First Publication No. 2004-249976
[Patent Document 2] Japanese Examined Patent Application, Second Publication No. H04-070162
[Patent Document 3] U.S. Pat. No. 10,915,179

### SUMMARY OF THE INVENTION

In the conventional vehicle height control device described above, since information on points where lift-up is required is managed for each vehicle, it is not possible to determine whether or not lift-up is required for a point where the vehicle is traveling for the first time. Thus, since the bottom of the vehicle may come into contact with a road with unevenness, a decrease in ride comfort or damage to the vehicle's underfloor components occurs.

The aspects of the present invention have been made in consideration of these circumstances, and one of the objects is to provide an automatic lift-up control device, an automatic lift-up management device, an automatic lift-up control system, an automatic lift-up control method, an automatic lift-up management method, and a storage medium capable of expanding a range in which the vehicle lift-up control can be automated.

In order to solve the above-described problems and achieve the above-described object, the present invention employs the following aspects.
(1) An automatic lift-up control device according to an aspect of the present invention includes: an acquisition unit which acquires position information indicating a position of a target vehicle and lift-up recommendation point information having a registered recommendation point for recommending lift-up based on information provided from a plurality of vehicles; a determination unit which determines whether or not the position of the target vehicle corresponds to the recommendation point registered in the lift-up recommendation point information; and a lift-up control unit which lifts up the target vehicle when it is determined that the position of the target vehicle corresponds to the recommendation point registered in the lift-up recommendation point information.
(2) In Aspect (1), the automatic lift-up control device may further include: an update control unit which generates update information of the lift-up recommendation point information based on at least one of an instruction for a lift operation by an occupant of the target vehicle and a vehicle state of the target vehicle.
(3) In Aspect (2), the update control unit may determine a point in which an index value related to the movement of the target vehicle in a height direction included in the vehicle state of the target vehicle exceeds a predetermined threshold value as a recommendation point to be added, and generate the update information including information on the determined recommendation point to be added.
(4) In Aspect (2), the update control unit may determine a point in which an instruction to avoid lift-up has been input by the occupant among the lift recommendation points registered in the lift-up recommendation point information as a recommendation point to be deleted from the lift-up recommendation point information, and generate the update information including information on the determined recommendation point to be deleted.
(5) In Aspect (2), the update control unit may determine a point in which an index value related to the movement of the target vehicle in a height direction included in the vehicle state of the target vehicle is equal to or lower than a threshold value among the recommendation points registered in the lift-up recommendation point information as a recommendation point to be deleted from the lift-up recommendation point information, and generate the update information including information on the determined recommendation point to be deleted.
(6) In Aspect (1), the acquisition unit may acquire the lift-up recommendation point information corresponding to a vehicle model of the target vehicle.
(7) In Aspect (1), the automatic lift-up control device may further include: a display control unit which causes a display device to display a screen for receiving an instruction to add a recommendation point to the lift-up recommendation point information and to delete the recommendation point registered in the lift-up recommendation point information.
(8) In Aspect (1), when it is determined that the position of the target vehicle does not correspond to the recommendation point registered in the lift-up recommendation point information, the lift-up control unit may lift up the target vehicle in response to the vehicle state of the target vehicle.
(9) In Aspect (3) or (5), the index value may include at least one of acceleration and suspension stroke.
(10) An automatic lift-up management device according to an aspect of the present invention includes: an acquisition unit which acquires information on a recommendation point for recommending lift-up from a plurality of vehicles; a management unit which aggregates information on the recommendation point and generates lift-up recommendation point information; and a provision unit which provides the lift-up recommendation point information to each of the plurality of vehicles.
(11) In Aspect (10), the management unit may update the lift-up recommendation point information based on information on a road provided from an external device.
(12) An automatic lift-up control system according to an aspect of the present invention includes Aspects (1) to (8) and Aspects (10) or (11).
(13) An automatic lift-up control method according to an aspect of the present invention causes a computer of an automatic lift-up control device to: acquire position information indicating a position of a target vehicle and lift-up recommendation point information having a registered recommendation point for recommending lift-up based on information provided from a plurality of vehicles; determine whether or not the position of the target vehicle corresponds to the recommendation point registered in the lift-up recommendation point information; and lift up the target vehicle when it is determined that the position of the target vehicle corresponds to the recommendation point registered in the lift-up recommendation point information.
(14) An automatic lift-up management method according to an aspect of the present invention stores a program causing a computer of an automatic lift-up management device to: acquire information on a recommendation point for recommending lift-up from a plurality of vehicles; aggregate information on the recommendation point and generate lift-up recommendation point information; and provide the lift-up recommendation point information to each of the plurality of vehicles.
(15) A storage medium according to an aspect of the present invention stores a program causing a computer of an automatic lift-up control device to: acquire position information indicating a position of a target vehicle and lift-up recommendation point information having a registered recommendation point for recommending lift-up based on information provided from a plurality of vehicles; determine whether or not the position of the target vehicle corresponds to the recommendation point registered in the lift-up recommendation point information; and lift up the target vehicle when it is determined that the position of the target vehicle corresponds to the recommendation point registered in the lift-up recommendation point information.
(16) A storage medium according to another aspect of the present invention causes a computer of an automatic lift-up management device to: acquire information on a recommendation point for recommending lift-up from a plurality of vehicles; aggregate information on the recommendation point and generate lift-up recommendation point information; and provide the lift-up recommendation point information to each of the plurality of vehicles.

According to Aspects (1) to (16), it is possible to expand the range in which the vehicle lift-up control can be automated. In particular, since the lift-up control can be automated even in places where each vehicle has little driving experience (for example, places where the vehicle is driven for the first time), the burden on the occupant in setting the lift-up can be reduced, the risk of sudden ground contact can be reduced, and the vehicle's driving performance can be improved.

According to Aspects (2) to (5), the lift-up recommendation point can be updated automatically. Further, unnecessary lift-ups can be suppressed by deleting recommendation points that are no longer needed.

According to Aspect (6), highly accurate lift-up control can be performed according to the vehicle model.

### BRIEF DESCRIPTION OF THE DRAWINGS

FIG. 1 is a diagram illustrating an example of a configuration of an automatic lift-up control system S according to an embodiment.

FIG. 2 is a diagram illustrating an example of a lift map LM according to the embodiment.

FIG. 3 is a functional block diagram illustrating an example of a configuration of a vehicle M according to the embodiment.

FIG. 4 is a diagram illustrating an example of an individual vehicle lift map OLM according to the embodiment.

FIG. 5 is a diagram illustrating an example of vehicle state information VS according to the embodiment.

FIG. 6 is a flowchart illustrating an example of a flow of a process of an automatic lift-up control device 100 according to the embodiment.

FIG. 7 is a flowchart illustrating an example of a flow of a process for lift control by the automatic lift-up control device 100 according to the embodiment in response to a user operation.

FIG. 8 is a diagram illustrating an example of a determination map (during lift-on) DM2 according to the embodiment.

FIG. 9 is a flowchart illustrating an example of a flow of a process of automatic lift control by the automatic lift-up control device 100 according to the embodiment.

FIG. 10 is a flowchart illustrating an example of a flow of a process of initial shock control by the automatic lift-up control device 100 according to the embodiment.

FIG. 11 is a diagram illustrating an example of a determination map (during lift-off) DM1 according to the embodiment.

FIG. 12 is a flowchart illustrating an example of a flow of a process of an automatic lift-up management device 1 according to the embodiment.

FIG. 13 is a diagram illustrating an example of a determination map (during lift-off) DM1 and a determination map (during lift-on) DM2 according to the embodiment.

FIG. 14 is a flowchart illustrating an example of a flow of a process for deleting and updating lift recommendation points by the automatic lift-up management device 1 according to the embodiment.

### DETAILED DESCRIPTION OF THE INVENTION

Hereinafter, embodiments of an automatic lift-up control device, an automatic lift-up management device, an automatic lift-up control system, an automatic lift-up control method, an automatic lift-up management method, and a storage medium of the present invention will be described with reference to the drawings. In the automatic lift-up control system of the embodiment, information on points where lift-up is recommended (hereinafter, referred to as “lift recommendation points”) is shared based on information obtained from a plurality of vehicles that can communicate via a network. Accordingly, it is possible to expand the range in which the vehicle lift-up control can be automated.

### System Configuration

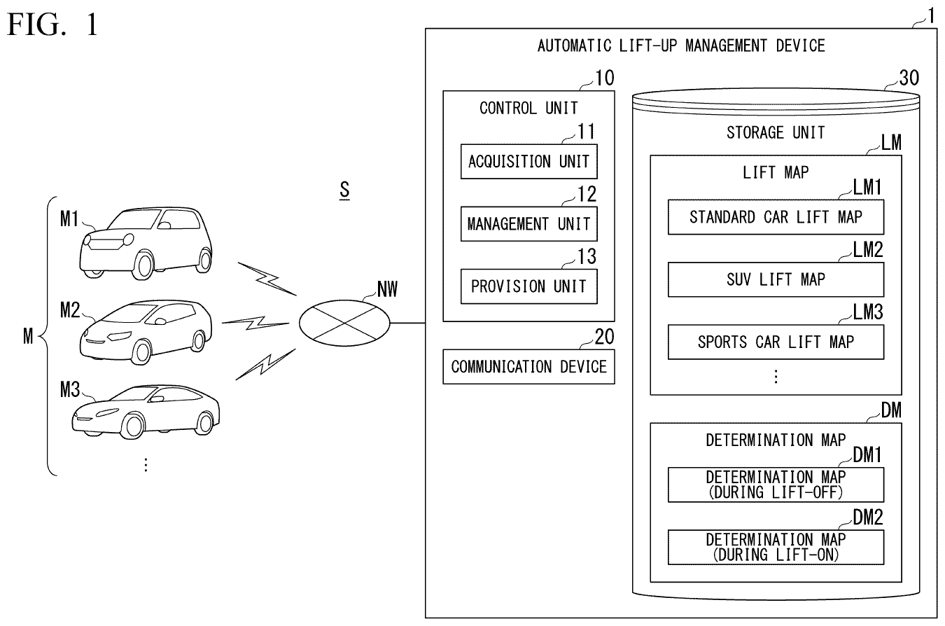

FIG. 1 is a diagram illustrating an example of a configuration of an automatic lift-up control system S according to the embodiment. The automatic lift-up control system S includes, for example, a plurality of vehicles M (automatic lift-up control devices mounted on the vehicles M) and an automatic lift-up management device 1. The vehicle M and the automatic lift-up management device 1 are connected to each other so as to be able to communicate with each other via a wireless or wired communication network NW. The communication network NW includes, for example, a cellular network, a Wi-Fi network, an Internet, a local area network (LAN), a wide area network (WAN), and the like. The vehicle is, for example, a four-wheeled, two-wheeled, three-wheeled, or other mobile object. Hereinafter, a description will be given of an example in which the vehicle is a four-wheeled vehicle. The vehicle M includes multiple models (types) of vehicles. The vehicle M includes, for example, a standard car M1, a sport utility vehicle (SUV) M2, a sports car M3, and the like. In addition, the vehicle M may include various vehicle models such as large vehicles, medium-sized vehicles, small cars, wagons, trucks, and buses. The vehicle M is an example of a “target vehicle.”

### Automatic Lift-Up Management Device

The automatic lift-up management device 1 comprehensively manages information on lift recommendation points based on information obtained from the plurality of vehicles M that can communicate via the communication network NW. The automatic lift-up management device 1 functions as a cloud server. The automatic lift-up management device 1 includes, for example, a control unit 10, a communication device 20, and a storage unit 30. The communication device 20 communicates with external devices such as each vehicle M via the communication network NW. The control unit 10 includes, for example, an acquisition unit 11, a management unit 12, and a provision unit 13.

Each of the functional units of the control unit 10 is realized by a computer processor, such as a central processing unit (CPU) or an electronic control unit (ECU), executing a program (software). Each of the functional units of the control unit 10 may be realized by hardware (circuit units) such as a large scale integration (LSI), an application specific integrated circuit (ASIC), a field-programmable gate array (FPGA), or a graphics processing unit (GPU), or may be realized by a combination of software and hardware. Each of the functions of the control unit 10 may be realized by a single device, or may be a system in which a plurality of devices connected via the communication network NW operate in cooperation with each other.

The acquisition unit 11 acquires various information transmitted from the plurality of vehicles M via the communication network NW. For example, the acquisition unit 11 acquires information on lift recommendation points to be added or deleted (candidates), vehicle state information on the traveling state of the vehicle, and the like. The vehicle state information includes, for example, the vehicle position, the vehicle speed, the vehicle height (vertical) acceleration (hereinafter, referred to as “vertical G”), the vehicle suspension stroke information, and the like. The acquisition unit 11 acquires information on the start and end of road construction works from an external device such as a company or organization that manages information on road construction works, via the communication network NW.

The management unit 12 aggregates information on lift recommendation points provided by the plurality of vehicles M to generate and update a lift map LM, and stores the map in the storage unit 30. The lift map LM is an example of “lift-up recommendation point information.” That is, the lift map LM is information in which recommendation points where lift-up is recommended based on information provided from the plurality of vehicles are registered. Further, the management unit 12 updates the lift map LM based on information on roads provided from the external device.

The provision unit 13 provides the lift map LM or determination map DM stored in the storage unit 30 to each vehicle M in response to a request from the vehicle M.

The storage unit 30 stores various information necessary for controlling the lift-up of the vehicle M. The storage unit 30 stores, for example, the lift map LM and the determination map DM. The storage unit 30 is realized by an electrically erasable programmable read only memory (EEPROM), a read only memory (ROM), a random access memory (RAM), and the like. At least a part of the information included in the storage unit 30 may be stored in an external device capable of communicating with the automatic lift-up management device 1.

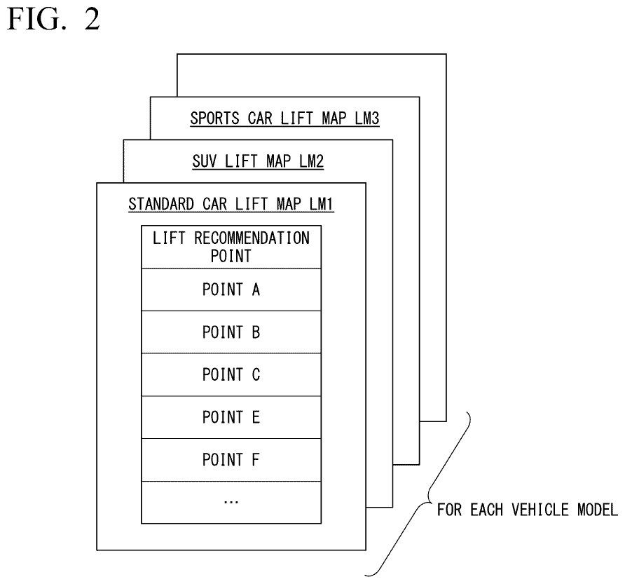

The position information of the plurality of lift recommendation points is registered in the lift map LM. The lift recommendation point has a certain spread (range) centered on the registered point. The registration point indicates a single point where an event (step, bump, and the like) that requires lift-up occurs. The lift recommendation point is indicated by, for example, a circle of a predetermined radius centered on the registered point. FIG. 2 is a diagram illustrating an example of the lift map LM according to the embodiment. The lift map LM is managed separately for each vehicle model. This is because the minimum ground clearance (height of the bottom of the vehicle when lifted off) differs for each vehicle model, and the risk of touching the ground differs. The lift maps LM include, for example, a standard car lift map LM1 associated with the standard car M1, an SUV lift map LM2 associated with the SUV M2, a sports car lift map LM3 associated with the sports car M3, and the like.

The determination map DM is reference information used when generating and updating the lift map LM by the management unit 12. The determination map DM includes, for example, a determination map (during lift-off) DM1, a determination map (during lift-on) DM2, and the like. The determination map DM will be described in detail later.

### Vehicle (Automatic Lift-Up Control Device)

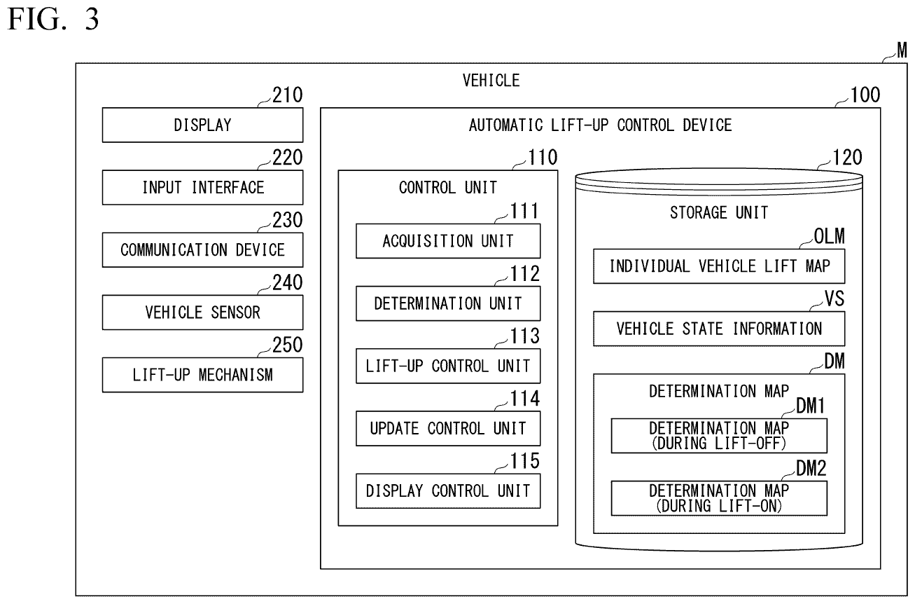

FIG. 3 is a functional block diagram illustrating an example of the configuration of the vehicle M according to the embodiment. The vehicle M includes, for example, an automatic lift-up control device 100, a display 210, an input interface 220, a communication device 230, a vehicle sensor 240, a lift-up mechanism 250, and the like in addition to mechanisms for driving.

The display 210 displays various information on the lift-up control. The display 210 displays a graphical user interface (GUI) image that accepts various operations by an occupant (for example, a driver, a passenger, or the like, also referred to as a “user”) of the vehicle M. The display 210 is installed, for example, on an instrument panel inside the vehicle M. The display 210 is, for example, a liquid crystal display (LCD), an organic electroluminescence (EL) display, and the like. The display 210 is an example of a “display device”.

The input interface 220 accepts various input operations by the occupants of the vehicle M. The input operation (operation signal) received by the input interface 220 is output to the automatic lift-up control device 100. The input interface 220 includes, for example, a touch panel, a switch, a key, a microphone, and the like. When the display 210 is a touch panel, the functionality of the input interface 220 may be incorporated into the display 210.

The communication device 230 communicates with external devices such as the automatic lift-up management device 1 via the communication network NW. The various information acquired by the communication device 230 is output to the automatic lift-up control device 100.

The vehicle sensor 240 detects various information on the traveling state of the vehicle M. The vehicle sensor 240 includes a vehicle speed sensor that detects the speed of the vehicle M, an acceleration sensor that detects the acceleration, a yaw rate sensor that detects the yaw rate (for example, the rotational angular velocity around a vertical axis passing through the center of gravity of the vehicle M), a direction sensor that detects the direction of the vehicle M, a position sensor that detects the position of the vehicle M, and the like. The position sensor acquires position information (longitude and latitude information) from, for example, a global positioning system (GPS) device. In addition, the vehicle sensor 240 may include an accelerator opening sensor attached to an accelerator pedal that receives an acceleration instruction, a brake depression sensor attached to a brake pedal that receives a braking instruction, and the like. The result detected by the vehicle sensor 240 is output to the automatic lift-up control device 100.

The lift-up mechanism 250 adjusts the minimum ground clearance of the vehicle M vertically (lift-up, lift-down) according to the control of the automatic lift-up control device 100 and the input operation of the input interface 220 (for example, a switch) by the occupant. The lift-up mechanism 250 includes, for example, an air suspension equipped with an air spring.

The automatic lift-up control device 100 controls the lift-up of the vehicle M. The automatic lift-up control device 100 includes, for example, a control unit 110 and a storage unit 120. The control unit 110 includes, for example, an acquisition unit 111, a determination unit 112, a lift-up control unit 113, an update control unit 114, and a display control unit 115.

Each of the functional units of the control unit 110 is realized by, for example, a computer processor such as a CPU executing a program (software). Each of the functional units of the control unit 110 may be realized by hardware (circuit unit) such as an LSI, an ASIC, an FPGA, or a GPU, or may be realized by a combination of software and hardware. Each of the functions of the control unit 110 may be realized by a single device, or may be a system in which multiple devices connected via the communication network NW operate in cooperation with each other.

The acquisition unit 111 acquires the lift map LM or the determination map DM corresponding to the vehicle model of the vehicle M from the automatic lift-up management device 1. In addition, the acquisition unit 111 acquires the vehicle state (for example, position, vertical G, vehicle speed, and the like) of the vehicle M detected by the vehicle sensor 240.

The determination unit 112 determines whether or not the position of the vehicle M corresponds to the lift recommendation point registered in the lift map LM.

When the determination unit 112 determines that the position of the vehicle M corresponds to the lift recommendation point registered in the lift map LM, the lift-up control unit 113 controls the lift-up mechanism 250 to automatically lift up the vehicle M. Furthermore, the lift-up control unit 113 may perform control to change the damping force of the damper in addition to the lift-up control.

The update control unit 114 generates update information for updating the lift map LM based on at least one of an instruction regarding a lift operation (lift-up operation, lift-down operation) by the occupant of the vehicle M or a vehicle state of the vehicle M, and provides the update information to the automatic lift-up management device 1. The update information includes vehicle state information, which will be described later. The update control unit 114 determines a point in which the acceleration in the height direction of the vehicle, which is included in the vehicle state of the vehicle M, exceeds a predetermined threshold value as a recommendation point to be added, and generates update information including information on the determined recommendation point to be added. Further, the update control unit 114 determines a point in which an instruction to avoid lift-up has been input by the occupant among the lift recommendation points registered in the lift map LM as a recommendation point to be deleted from the lift map LM, and generates update information including information on the determined recommendation point to be deleted. Further, the update control unit 114 determines a point in which the acceleration in the vehicle height direction included in the vehicle state of the vehicle M is equal to or lower than a threshold value among the lift recommendation points registered in the lift map LM as a recommendation point to be deleted from the lift map LM, and generates determined update information including information on the recommendation point to be deleted. The process of the update control unit 114 will be described in detail later. Furthermore, the update control unit 114 may generate update information based on the result of comparing the vehicle suspension stroke, included in the vehicle state of the vehicle M, with a threshold value instead of (or in addition to) the vehicle's vertical acceleration. The acceleration and the suspension stroke are examples of “index values related to the movement in the vehicle height direction”.

The display control unit 115 causes the display 210 to display a screen for receiving an instruction to add a new lift recommendation point to the lift map LM or to delete a lift recommendation point registered on the lift map LM.

The storage unit 120 stores various information necessary for controlling the lift-up of the vehicle M. The storage unit 120 stores, for example, an individual vehicle lift map OLM, vehicle state information VS, a determination map DM, and the like. The storage unit 120 is realized by EEPROM, ROM, RAM, and the like. At least a part of the information included in the storage unit 120 may be stored in an external device capable of communicating with the vehicle M.

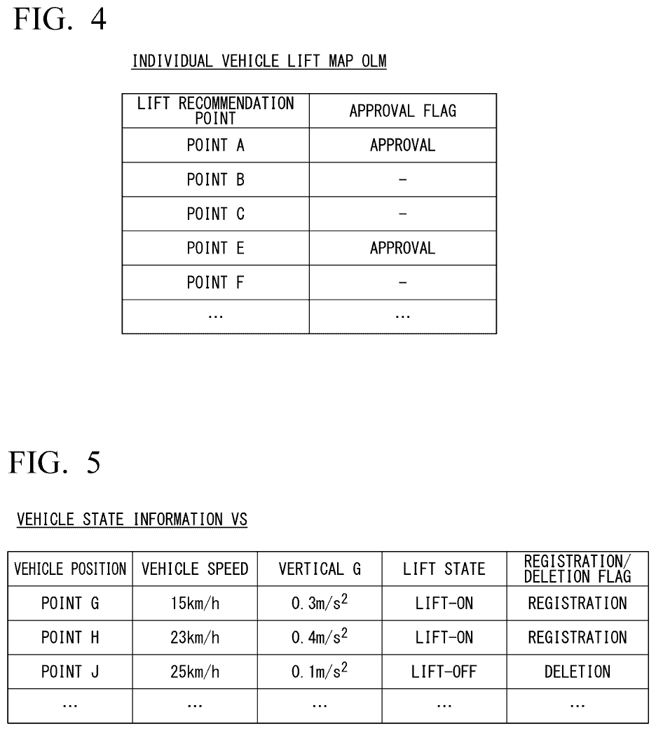

The individual vehicle lift map OLM is generated based on the lift map LM provided from the automatic lift-up management device 1. The individual vehicle lift map OLM is local data managed for each vehicle M. FIG. 4 is a diagram illustrating an example of the individual vehicle lift map OLM according to the embodiment. The individual vehicle lift map OLM, for example, registers lift recommendation points corresponding to the lift recommendation points registered in the lift map LM, and an approval flag indicating whether or not the occupant of the vehicle M has approved the lift-up for each lift recommendation point in association.

The vehicle state information VS is a record of the vehicle state of the vehicle M detected by the vehicle sensor 240. FIG. 5 is a diagram illustrating an example of the vehicle state information VS according to the embodiment. The vehicle state information VS includes, for example, the vehicle position, the vehicle speed, the vertical G, the lift state (lift on, lift off), and the like. The vehicle state information VS further includes flag information that specifies whether or not a point corresponding to the vehicle position is registered as a lift recommendation point, or whether or not a point is deleted from the registered lift recommendation points in response to the vehicle state of the vehicle M and instructions from the occupant.

### Process Flow

### Process Flow of Automatic Lift-Up Control Device 100

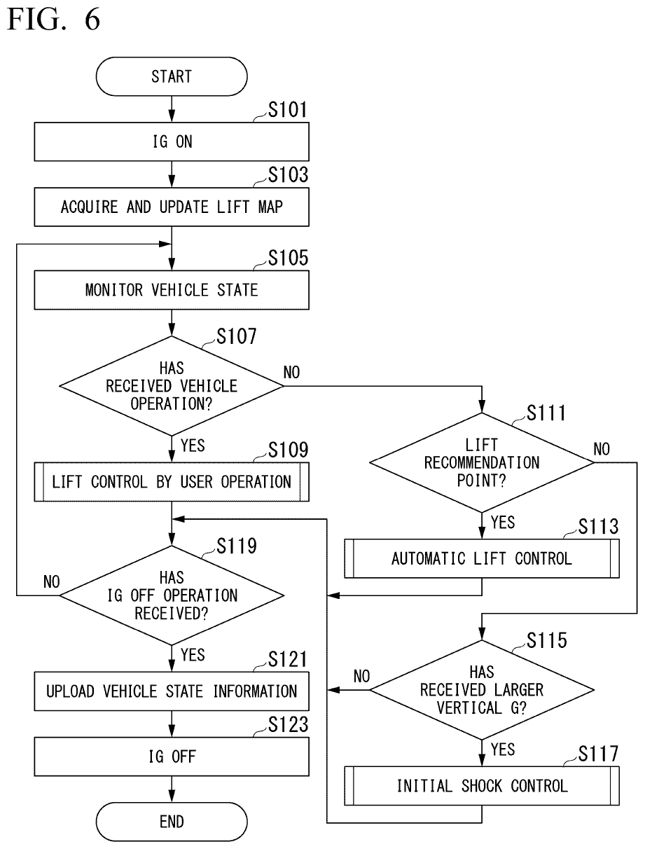

Next, the process of the automatic lift-up control device 100 will be described. FIG. 6 is a flowchart illustrating an example of a flow of a process of the automatic lift-up control device 100 according to the embodiment.

First, the acquisition unit 111 acquires a signal indicating that the ignition (IG) of the vehicle M has been turned on in response to an operation by the occupant (step S101), and then acquires the lift map LM corresponding to the vehicle model of the vehicle M from the automatic lift-up management device 1, and the update control unit 114 updates the individual vehicle lift map OLM stored in the storage unit 120 using the acquired lift map LM (step S103). Here, the update control unit 114 adds, for example, lift recommendation points included in the acquired lift map LM that are not registered in the individual vehicle lift map OLM to the individual vehicle lift map OLM.

Next, the acquisition unit 111 monitors the vehicle state by continuously acquiring the vehicle state information (for example, position, vertical G, vehicle speed, and the like) related to the traveling of the vehicle M detected by the vehicle sensor 240 (step S105).

Next, the determination unit 112 determines whether or not a lift operation by the occupant has been received (step S107). When it is determined that the lift operation has been received (step S107; Yes), the lift-up control unit 113 executes lift control based on the user operation (step S109). The lift control by the user operation will be described in detail later.

On the other hand, when it is determined that the lift operation has not been received (step S107; No), the determination unit 112 determines whether or not the position of the vehicle M acquired by the acquisition unit 111 corresponds to the lift recommendation point registered in the individual vehicle lift map OLM (step S111). When it is determined that the position of the vehicle M corresponds to the lift recommendation point (step S111; Yes), the lift-up control unit 113 performs the automatic lift control (step S113). The automatic lift control will be described in detail later.

On the other hand, when it is determined that the position of the vehicle M does not correspond to the lift recommendation point (step S111; No), the determination unit 112 determines whether or not the vehicle M has received a large vertical G based on the vehicle state information acquired by the acquisition unit 111 (step S115). For example, the determination unit 112 determines that the vehicle M has received a large vertical G when the detected vertical G is equal to or higher than a predetermined threshold value. When it is determined that the vehicle M has received a large vertical G (step S115; Yes), it is expected that lift-up will likely be recommended at this point. Therefore, the lift-up control unit 113 performs the initial shock control (step S117). The initial shock control will be described in detail later.

Next, the lift-up control unit 113 determines whether or not an operation to turn off the ignition by the occupant has been received (step S119). When it is determined that the operation to turn off the ignition has not been received (step S119; No), the process returns to step S105, and the subsequent process is repeated.

On the other hand, when it is determined that the operation to turn off the ignition has been received (step S119; Yes), the update control unit 114 uploads (transmits) the vehicle state information VS (update information) and information indicating the vehicle model of the vehicle M to the automatic lift-up management device 1 (step S121). Thereafter, the ignition of the vehicle M is turned off (step S123), and the process of this flowchart ends.

### Lift Control by User Operation

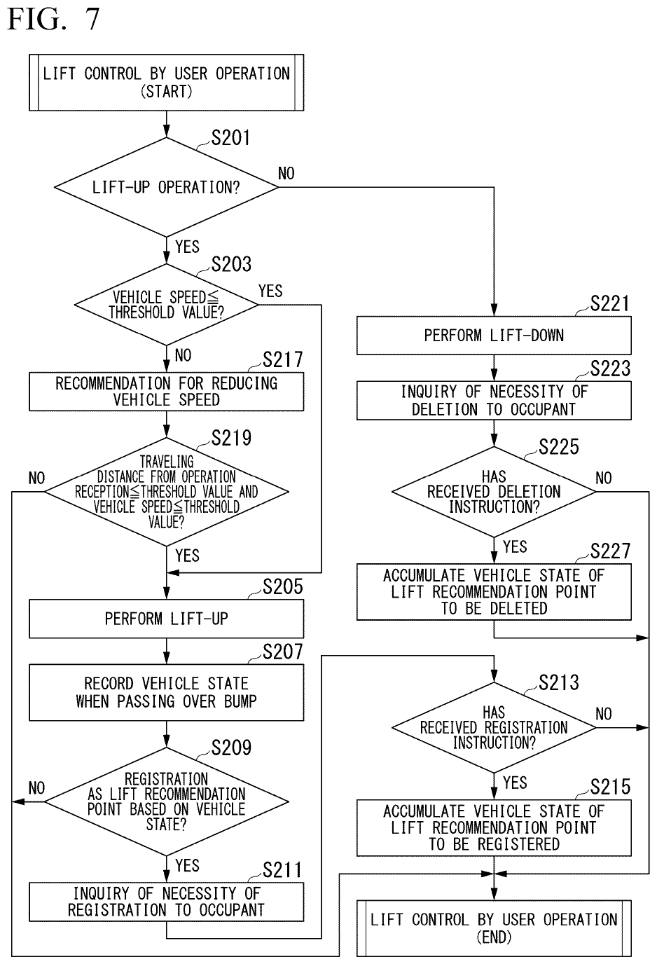

Next, the details of the lift control by the user operation in step S109 will be described. FIG. 7 is a flowchart illustrating an example of a flow of a process of lift control by the user operation of the automatic lift-up control device 100 according to the embodiment.

First, the lift-up control unit 113 determines whether or not the lift operation received in step S107 is a lift-up operation (step S201).

When it is determined that the received lift operation is a lift-up operation (step S201; Yes), the lift-up control unit 113 determines whether or not the vehicle speed of the vehicle M is equal to or lower than a predetermined threshold value based on the vehicle state information acquired by the acquisition unit 111 (step S203). When it is determined that the vehicle speed is equal to or lower than the predetermined vehicle speed threshold value (step S203; Yes), the lift-up control unit 113 controls the lift-up mechanism 250 to lift up the vehicle M (step S205). Next, the lift-up control unit 113 records the vehicle state when the vehicle M goes over a bump (such as an uneven road) in the lift-up state in the vehicle state information VS (step S207).

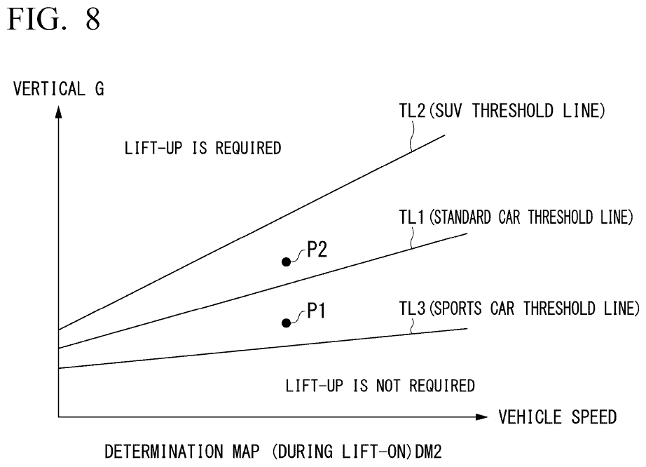

Next, the update control unit 114 determines whether or not to register this point as a lift recommendation point based on the vehicle state when the vehicle goes over the bump (step S209). For example, the update control unit 114 compares the detected vertical G and vehicle speed with the determination map DM to determine whether or not to register this point as a lift recommendation point. FIG. 8 is a diagram illustrating an example of the determination map (during lift-on) DM2 according to the embodiment. The detected vertical G and vehicle speed are mapped on this determination map (during lift-on) DM2, and based on the positional relationship with the threshold line corresponding to the vehicle model M, it is determined whether or not this point should be registered as a lift recommendation point. For example, when the vehicle M is a standard car, the mapped point P1 is located below the standard car threshold line TL1 in the vertical G-axis direction, and therefore the point P1 is determined not to be registered as a lift recommendation point. On the other hand, since the mapped point P2 is located above the standard car threshold line TL1 in the vertical G-axis direction, it is determined that this point P2 should be registered as a lift recommendation point. When it is determined that the point should be registered as a lift recommendation point (step S209; Yes), the display control unit 115 causes the display 210 to display an inquiry screen for receiving an instruction from the occupant as to whether or not to register the point as an additional lift recommendation point (step S211). Furthermore, in FIG. 8, as an example, a determination map including information on threshold lines for three types of vehicle models (standard cars, SUVs, and sports cars) is illustrated, but the types and number of vehicle models are not limited thereto and may be variable. For example, the determination map may include information on vehicle models such as trucks.

Next, the update control unit 114 determines whether or not an instruction to register a lift recommendation point by the occupant has been received (step S213). When it is determined that an instruction to register a lift recommendation point from the occupant has been received (step S213; Yes), the update control unit 114 accumulates the vehicle state of the lift recommendation point to be registered (step S215). For example, the update control unit 114 sets a registration/deletion flag of the data corresponding to the vehicle position to be added in the vehicle state information VS as illustrated in FIG. 5 to “registration.”

On the other hand, when it is determined that the vehicle speed is not equal to or lower than the predetermined vehicle speed threshold value (step S203; No), the display control unit 115 causes the display 210 to display a recommendation screen for recommending the occupant to reduce the speed in order to perform lift-up (step S217). Next, the lift-up control unit 113 determines whether or not the conditions that the traveling distance of the vehicle M from the time when the lift operation is received in step S107 is equal to or shorter than a predetermined threshold value and the current vehicle speed is equal to or lower than a predetermined threshold value are satisfied (step S219). When it is determined that this condition is satisfied (step S219; Yes), the lift-up control unit 113 controls the lift-up mechanism 250 to lift up the vehicle M (step S205), and performs the subsequent process.

On the other hand, when it is determined that the above-described conditions are not satisfied (step S219; No), when it is determined that the point is not to be registered as a lift recommendation point (step S209; No), or when it is determined that an instruction from the occupant to register a lift recommendation point has not been received (step S213; No), the process of this flowchart ends.

On the other hand, when it is determined that the received lift operation is not a lift-up operation (for example, a lift-down operation) (step S201; No), the lift-up control unit 113 controls the lift-up mechanism 250 to perform the lift-down of the vehicle M (step S221). Next, the display control unit 115 causes the display 210 to display an inquiry screen for receiving an instruction from the occupant as to whether or not to delete the lift recommendation point (step S223). Next, the update control unit 114 determines whether or not an instruction to delete the lift recommendation point from the occupant has been received (step S225). When it is determined that an instruction to delete a lift recommendation point from the occupant has been received (step S225; Yes), the update control unit 114 accumulates the vehicle state of the lift recommendation point to be deleted (step S227). For example, the update control unit 114 sets the registration/deletion flag corresponding to the vehicle position (lift recommendation point) to be deleted in the vehicle state information VS as illustrated in FIG. 5 to “delete.” In this way, the vehicle M determines the necessity of registering and deleting the lift recommendation points, and the final approval is left to the occupant. Furthermore, the final determination regarding the registration and deletion of lift recommendation points is made by the vehicle M, and approval by the occupant may be omitted. As described above, the process of the flowchart ends.

### Automatic Lift Control

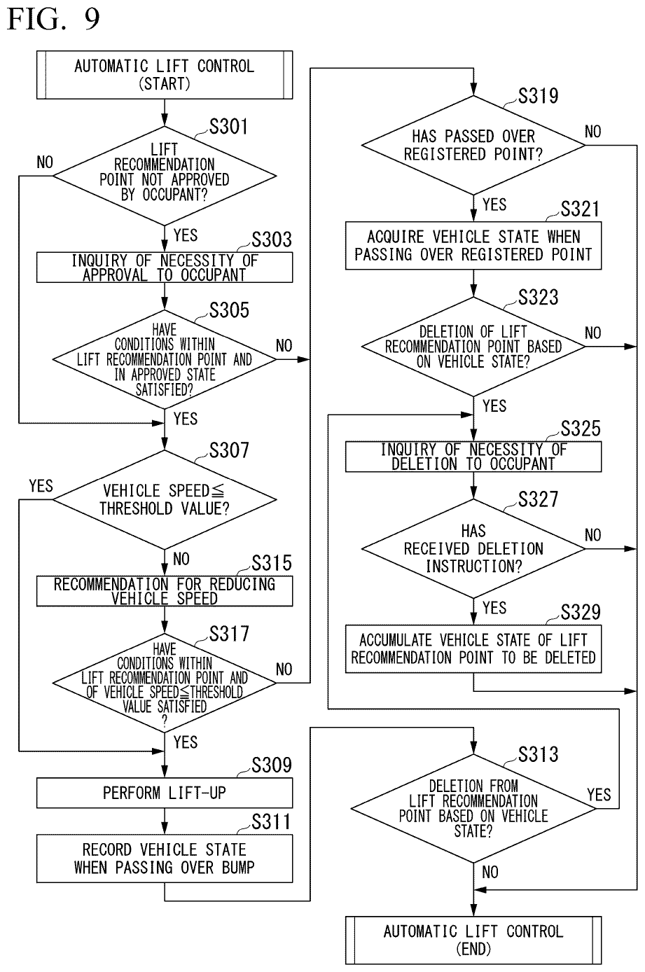

Next, the details of the automatic lift-up control in step S113 will be described. FIG. 9 is a flowchart illustrating an example of a flow of a process of the automatic lift-up control by the automatic lift-up control device 100 according to the embodiment.

First, the lift-up control unit 113 determines whether or not the lift recommendation point registered in the individual vehicle lift map OLM that is determined to correspond to the position of the vehicle M in step S111 is a lift recommendation point that has not been approved by the occupant (step S301). For example, the lift-up control unit 113 performs this determination based on an approval flag associated with the lift recommendation point registered in the individual vehicle lift map OLM as illustrated in FIG. 4. When it is determined that the lift recommendation point is not approved by the occupant (step S301; Yes), the display control unit 115 causes the display 210 to display an inquiry screen for receiving an instruction from the occupant regarding whether or not to approve the lift-up (step S303). Next, the lift-up control unit 113 determines whether the conditions that the position of the vehicle M is within the lift recommendation point and an approval instruction from the occupant has been received are satisfied (step S305).

When it is determined that the above-described conditions are satisfied (step S305; Yes) or when it is determined that the lift recommendation point is not an unapproved lift recommendation point (for example, the lift recommendation point is an approved lift recommendation point) (step S301; No), the lift-up control unit 113 determines whether or not the vehicle speed of the vehicle M is equal to or lower than a predetermined vehicle speed threshold value based on the vehicle state information acquired by the acquisition unit 111 (step S307). When it is determined that the vehicle speed is equal to or lower than the predetermined vehicle speed threshold value (step S307; Yes), the lift-up control unit 113 controls the lift-up mechanism 250 to lift up the vehicle M (step S309). Next, the lift-up control unit 113 records the vehicle state when the vehicle M goes over a bump (such as an uneven road) in a lift-up state in the vehicle state information VS (step S311). Furthermore, when the lift-up control unit 113 receives an approval instruction from the occupant, the lift-up control unit updates the approval flag associated with the lift recommendation point registered in the individual vehicle lift map OLM to “approved.” Accordingly, once a lift recommendation point has been approved for lift-up, further approval by the occupant is no longer required and lift-up will be performed automatically.

Next, the update control unit 114 determines whether or not to delete this point from the list of lift recommendation points based on the vehicle state when going over the bump (step S313). For example, the update control unit 114 determines whether or not to delete the lift recommendation point based on the result of comparing the detected vertical G and vehicle speed with the determination map (during lift-on) DM2. By performing such a determination, it is possible to delete the lift recommendation point that was once registered when, for example, the bump at the lift recommendation point previously approved by the occupant has been deleted and lift-up is no longer necessary, or when the occupant mistakenly approved the point in the past. When it is determined that the lift recommendation point should not be deleted (step S313; No), the process of this flowchart ends.

On the other hand, when it is determined that the vehicle speed is not equal to or lower than a predetermined vehicle speed threshold value (step S307; No), the display control unit 115 causes the display 210 to display a recommendation screen for recommending the occupant to reduce the speed in order to perform lift-up (step S315). Next, the lift-up control unit 113 determines whether or not the conditions that the position of the vehicle M is within a lift recommendation point and the current vehicle speed is equal to or lower than a predetermined threshold value are satisfied (step S317). When it is determined that this condition is satisfied (step S317; Yes), the lift-up control unit 113 controls the lift-up mechanism 250 to lift up the vehicle M (step S309), and performs the subsequent process.

On the other hand, when it is determined that the condition of step S305 is not satisfied (step S305; No), or when it is determined that the condition of step S317 is not satisfied (step S317; No), it is determined whether or not the vehicle M has passed over a registered point (the center of the lift recommendation point) (step S319).

Next, when it is determined that the vehicle M has passed over the registered point (step S319; Yes), the acquisition unit 111 acquires the vehicle state (vehicle speed and vertical G) at the time of passing over the registered point (step S321). Next, the update control unit 114 determines whether or not to delete the registered point from the list of lift recommendation points based on the vehicle state at the time of passing over the registered point (step S323). For example, the update control unit 114 determines whether or not to delete the lift recommendation point based on the result of comparing the detected vertical G and vehicle speed with the determination map (during lift-off) DM1.

When it is determined that the lift recommendation point should be deleted (step S323; Yes), the display control unit 115 displays an inquiry screen on the display 210 to receive an instruction from the occupant as to whether or not the lift recommendation point should be deleted (step S325). Next, the update control unit 114 determines whether or not an instruction to delete the lift recommendation point from the occupant has been received (step S327). When it is determined that an instruction to delete the lift recommendation point from the occupant has been received (step S327; Yes), the update control unit 114 accumulates the vehicle state of the lift recommendation point to be deleted (step S329). For example, the update control unit 114 sets the registration/deletion flag corresponding to the vehicle position (lift recommendation point) to be deleted in the vehicle state information VS as illustrated in FIG. 5 to “delete.” In this way, the vehicle M determines the necessity of deleting the lift recommendation point, and the final approval is left to the occupant. Furthermore, regarding the deletion of the lift recommendation point, the final determination is made by the vehicle M, and approval by the occupant may be omitted. As described above, the process of the flowchart ends.

On the other hand, when it is determined that the vehicle M has not passed over the registered point (step S319; No), when it is determined that the point should not be deleted from the lift recommendation points (step S323; No), or when it is determined that an instruction from the occupant to delete the lift recommendation point has not been received (step S327; No), the process of this flowchart ends.

Furthermore, when it is determined that the lift recommendation point should be deleted (step S313; Yes), the display control unit 115 causes the display 210 to display an inquiry screen to receive instructions from the occupant as to whether or not to delete the lift recommendation point (step S325), and a subsequent process is performed.

### Initial Shock Control

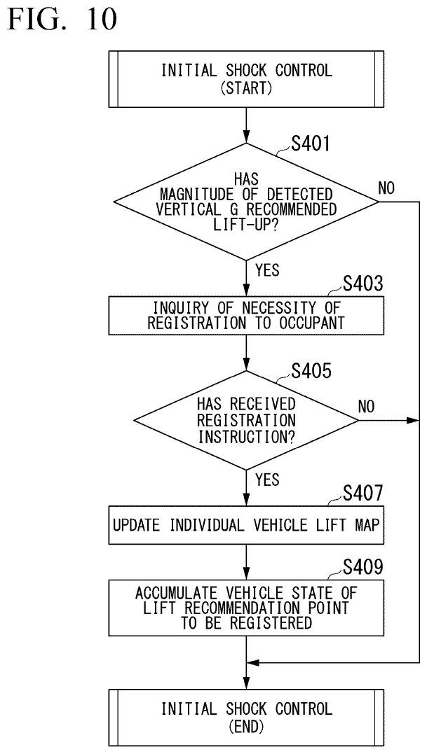

Next, the details of the initial shock control in step S117 will be described. FIG. 10 is a flowchart illustrating an example of a flow of a process of the initial shock control by the automatic lift-up control device 100 according to the embodiment.

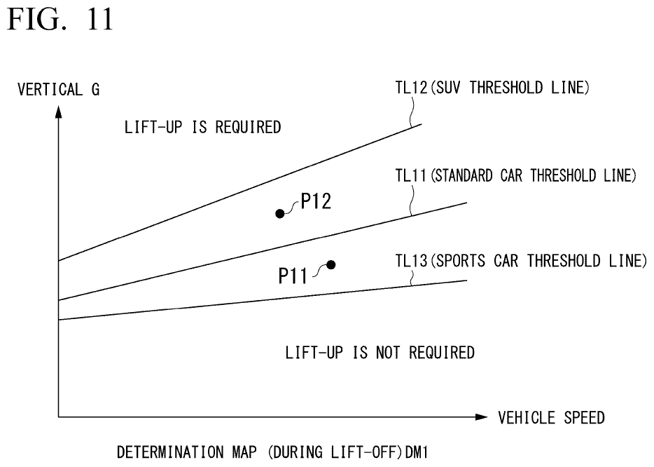

First, the update control unit 114 determines whether or not the magnitude of the vertical G detected in the vehicle M recommends lift-up based on the vehicle state information acquired by the acquisition unit 111 (step S401). For example, the update control unit 114 compares the detected vertical G and vehicle speed with the determination map DM to determine whether or not the magnitude of the detected vertical G recommends lift-up. FIG. 11 is a diagram illustrating an example of the determination map (during lift-off) DM1 according to the embodiment. The update control unit 114 maps the detected vertical G and vehicle speed on this determination map (during lift-off) DM1, and determines whether or not the magnitude recommends lift-up based on the positional relationship with the threshold line corresponding to the vehicle model of the vehicle M. For example, when the vehicle M is a standard car, the mapped point P11 is located below the standard car threshold line TL11 in the vertical G-axis direction, and therefore, this point P11 is not determined to be a magnitude that recommends lift-up (lift-up is not required). On the other hand, since the mapped point P12 is located above the standard car threshold line TL11 in the vertical G-axis direction, this point P12 is determined to be a magnitude that recommends lift-up (lift-up is required). Furthermore, FIG. 11 illustrates an example of the determination map including information on threshold lines for three types of vehicle models (standard car, SUVs, and sports cars), but the types and number of vehicle models are not limited to these and may be variable. For example, the determination map may include information on vehicle models such as trucks.

When it is determined that the magnitude recommends lift-up (step S401; Yes), the display control unit 115 causes the display 210 to display an inquiry screen for receiving an instruction from the occupant as to whether or not to additionally register a lift recommendation point (step S403). Further, the lift-up control unit 113 controls the lift-up mechanism 250 to lift up the vehicle M.

Next, the update control unit 114 determines whether or not an instruction to register a lift recommendation point by the occupant has been received (step S405). When it is determined that an instruction to register a lift recommendation point by the occupant has been received (step S405; Yes), the lift recommendation point is registered in the individual vehicle lift map OLM to update the individual vehicle lift map OLM (step S407). Next, the update control unit 114 accumulates the vehicle state of the lift recommendation point to be registered (step S409). For example, the update control unit 114 sets the registration/deletion flag corresponding to the vehicle position to be registered in the vehicle state information VS as illustrated in FIG. 5 to “registered.” In this way, the vehicle M determines the necessity of the lift recommendation point registration, and the final approval is left to the occupant. Regarding the registration of lift recommendation points, the final determination is made by the vehicle M, and approval by the occupant may be omitted. As described above, the process of the flowchart ends.

On the other hand, when it is determined that the magnitude does not recommend lift-up (step S401; No), or when it is determined that the instruction to register the point as a lift recommendation point has not been received (step S405; No), the process of this flowchart ends.

### Process Flow of Automatic Lift-Up Management Device 1

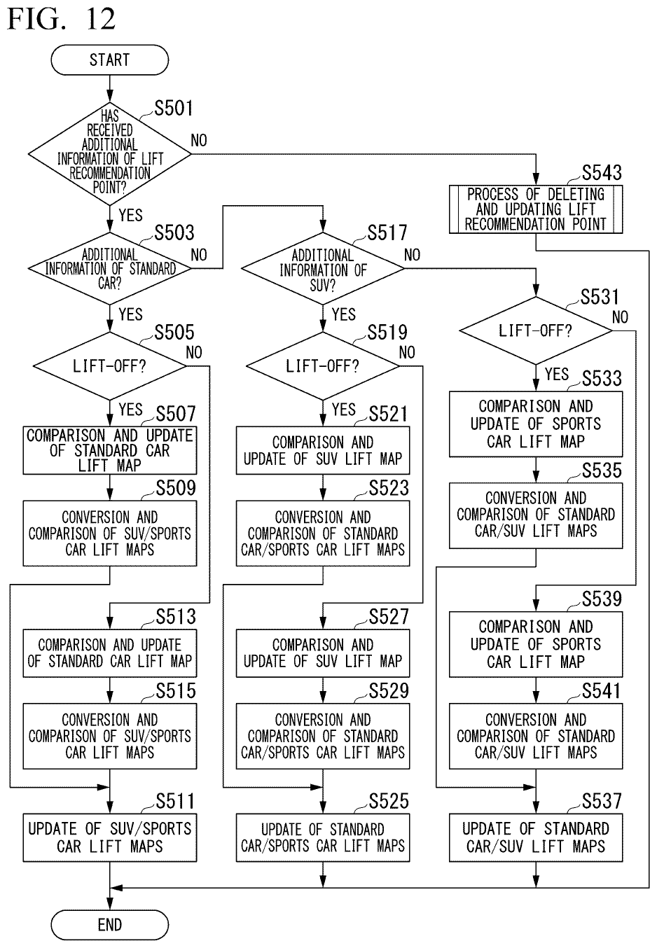

Next, a process of the automatic lift-up management device 1 will be described. FIG. 12 is a flowchart illustrating an example of a flow of a process of the automatic lift-up management device 1 according to the embodiment.

First, the management unit 12 determines whether or not the update information of the lift map LM received from each vehicle M is additional information requesting additional registration of the lift recommendation point (step S501). The management unit 12 determines whether or not the update information is additional information by referring to the registration/deletion flag of the vehicle state information VS included in the update information. When it is determined that the additional information is for the lift recommendation point (step S501; Yes), the management unit 12 determines whether or not the additional information is for a standard car based on the vehicle model information provided by each vehicle M (step S503). When it is determined that the additional information is for the standard car (step S503; Yes), the management unit 12 determines whether or not the additional information was obtained during lift-off by referring to the lift state of the vehicle state information VS included in the update information (step S505).

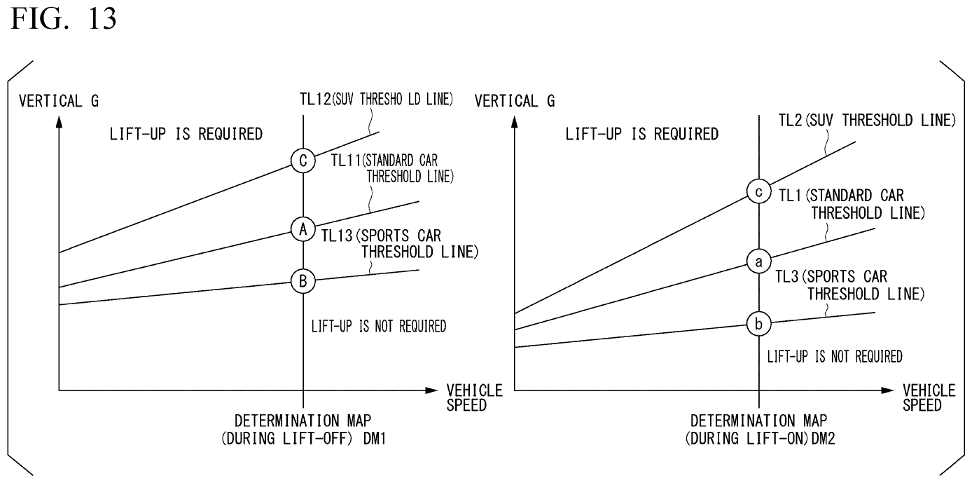

When it is determined that the information was obtained during lift-off (step S505; Yes), the management unit 12 updates the standard car lift map LM1 based on the result of comparing the vertical G and vehicle speed of the vehicle condition information VS included in the update information with the determination map (during lift-off) DM1 (step S507). FIG. 13 is a diagram illustrating an example of the determination map (during lift-off) DM1 and the determination map (during lift-on) DM2 according to the embodiment. A set of vertical G and vehicle speed included in the update information is mapped on such a determination map (during lift-off) DM1, and the standard car lift map LM1 is updated based on the positional relationship with the standard car threshold line TL11. When the mapped point is located below the standard car threshold line TL11 in the vertical G-axis direction, it is determined that the magnitude does not recommend lift-up (lift-up is not required). In this case, the vehicle position corresponding to this point is not registered as a lift recommendation point. On the other hand, when the mapped point is located above the standard car threshold line TL11 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is a standard car, to update the lift map LM corresponding to other vehicle models. For example, the management unit 12 converts the data of the vertical G detected in the vehicle M, which is a standard car, into data of the vertical G corresponding to other vehicle models (SUVs, sports cars) by multiplying the vertical G included in the update information provided from the vehicle M, which is a standard car, by a predetermined coefficient, and compares the converted value of the vertical G with the threshold line of the other vehicle models (SUVs, sports cars) in the determination map (during lift-off) DM1 (step S509). Furthermore, the management unit 12 updates the lift maps LM (SUV lift map LM2, sports car lift map LM3) of other vehicle models (SUVs, sports cars) based on the comparison result (step S511).

As illustrated in FIG. 13, when the update information provided from a standard car includes vehicle information of a set of vertical G and vehicle speed corresponding to “A”, this “A” exceeds the standard “B” for a sports car, so lift-up is required for the sports car. On the other hand, in the case of an SUV vehicle, this “A” does not exceed the standard “C” for SUVs, so lift-up is not required for SUVs. Furthermore, the determination map (during lift-off) DM1 and the determination map (during lift-on) DM2 may be normalized by the size of the bump (“B” during lift-off and “b” during lift-on correspond to the shock when going over the same bump). Accordingly, data during lift-on can be used to update maps during lift-off. Furthermore, FIG. 13 illustrates an example of a determination map including threshold line information for three types of vehicle models (standard cars, SUVs, and sports cars), but the types and number of vehicle models are not limited to these and may be variable. For example, the determination map may include information on vehicle models such as trucks.

Alternatively, an individual determination map for each vehicle model may be prepared in advance based on the vehicle specifications (spring characteristic value, front overhang, vehicle height, and damping force according to vehicle speed), and the lift map LM corresponding to other vehicle models may be updated by comparing this individual determination map for each vehicle model with the detection value of the vehicle state information VS included in the update information.

On the other hand, when it is determined that the information was not acquired during lift-off (step S505; No), the management unit 12 updates the standard car lift map LM1 based on the result of comparing the vertical G and vehicle speed included in the update information with the determination map (during lift-on) DM2 (step S513). A set of vertical G and vehicle speed included in the update information is mapped on a determination map (during lift-on) DM2 as illustrated in FIG. 13, and it is determined whether or not the magnitude recommends lift-up based on the positional relationship with the standard car threshold line TL1. When the mapped point is located below the standard car threshold line TL1 in the vertical G-axis direction, it is determined that the magnitude does not recommend lift-up (lift-up is not required). In this case, the vehicle position corresponding to this point is not registered as a lift recommendation point. On the other hand, when the mapped point is located above the standard car threshold line TL1 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is a standard car, to update the lift map LM corresponding to other vehicle models. For example, the management unit 12 converts the data of the vertical G detected in the vehicle M, which is a standard car, into data of the vertical G corresponding to other vehicle models (SUVs, sports cars) by multiplying the vertical G included in the update information provided from the vehicle M, which is a standard car, by a predetermined coefficient, and compares the changed value of the vertical G with the threshold line of the other vehicle models (SUVs, sports cars) in the determination map (during lift-on) DM2 (step S515). Furthermore, the management unit 12 updates the lift maps LM (SUV lift map LM2, sports car lift map LM3) of other vehicle models (SUVs, sports cars) based on the comparison result (step S511).

On the other hand, when it is determined that the additional information is not provided by the vehicle M which is a standard car (step S503; No), the management unit 12 determines whether or not the additional information is provided by the vehicle M which is an SUV (step S517). Next, when it is determined that the additional information is provided from the vehicle M, which is an SUV (step S517; Yes), the management unit 12 determines whether or not the additional information is acquired during lift-off (step S519).

When it is determined that the information is acquired during lift-off (step S519; Yes), the management unit 12 updates the SUV lift map LM2 based on the result of comparing the vertical G and vehicle speed included in the update information with the determination map (during lift-off) DM1 (step S521). A set of vertical G and vehicle speed included in the update information is mapped on a determination map (during lift-off) DM1 as illustrated in FIG. 13, and the SUV lift map LM2 is updated based on the positional relationship with the SUV threshold line TL12. When the mapped point is located below the SUV threshold line TL12 in the vertical G-axis direction, it is determined that the magnitude does not recommend lift-up (lift-up is not required). In this case, the vehicle position corresponding to this point is not registered as a lift recommendation point. On the other hand, when the mapped point is located above the SUV threshold line TL12 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is an SUV, to update the lift map LM corresponding to other vehicle models. For example, the management unit 12 converts the data of the vertical G detected by the SUV into data of the vertical G corresponding to other vehicle models (standard cars, sports cars) by multiplying the vertical G included in the update information provided by the vehicle M, which is an SUV, by a predetermined coefficient, and compares the converted value of the vertical G with the threshold line of the other vehicle models (standard cars, sports cars) in the determination map (during lift-off) DM1 (step S523). Furthermore, the management unit 12 updates the lift maps LM (standard car lift map LM1, sports car lift map LM3) of other vehicle models (standard cars, sports cars) based on the comparison result (step S525).

On the other hand, when it is determined that the information is not acquired during lift-off (step S519; No), the management unit 12 updates the SUV lift map LM2 based on the result of comparing the vertical G and vehicle speed included in the update information with the determination map (during lift-on) DM2 (step S527). A set of vertical G and vehicle speed included in the update information is mapped on a determination map (during lift-on) DM2 as illustrated in FIG. 13, and it is determined whether or not the magnitude recommends lift-up based on the positional relationship with the SUV threshold line TL2. When the mapped point is located below the SUV threshold line TL2 in the vertical G-axis direction, it is determined that the magnitude does not recommend lift-up (lift-up is not required). In this case, the vehicle position corresponding to this point is not registered as a lift recommendation point. On the other hand, when the mapped point is located above the SUV threshold line TL2 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is an SUV, to update the lift map LM corresponding to other vehicle models. For example, the management unit 12 converts the data of the vertical G detected by the SUV into data of the vertical G corresponding to other vehicle models (standard cars, sports cars) by multiplying the vertical G included in the update information provided by the vehicle M, which is an SUV, by a predetermined coefficient, and compares the changed value of the vertical G with the threshold line of the other vehicle models (standard cars, sports cars) in the determination map (during lift-on) DM2 (step S529). Furthermore, the management unit 12 updates the lift maps LM (standard car lift map LM1, sports car lift map LM3) of other vehicle models (standard cars, sports cars) based on the comparison result (step S525).

On the other hand, when it is determined that the additional information is not provided from the vehicle M which is an SUV (for example, provided from the vehicle M which is a sports car) (step S517; No), the management unit 12 determines whether or not the additional information is acquired during lift-off (step S531).

When it is determined that the information is acquired during lift-off (step S531; Yes), the management unit 12 updates the sports car lift map LM3 based on the result of comparing the vertical G and vehicle speed included in the update information with the determination map (during lift-off) DM1 (step S533). A set of vertical G and vehicle speed included in the update information is mapped on a determination map (during lift-off) DM1 as shown in FIG. 13, and the sports car lift map LM3 is updated based on the positional relationship with the sports car threshold line TL13. When the mapped point is located below the sports car threshold line TL13 in the vertical G-axis direction, it is determined that the magnitude does not recommend lift-up (lift-up is not required). In this case, the vehicle position corresponding to this point is not registered as a lift recommendation point. On the other hand, when the mapped point is located above the sports car threshold line TL13 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is a sports car, to update the lift map LM corresponding to other vehicle models. For example, the management unit 12 converts the data of the vertical G detected in the sports car into data of the vertical G corresponding to other vehicle models (standard cars, SUVs) by multiplying the vertical G included in the update information provided by the vehicle M, which is a sports car, by a predetermined coefficient, and compares the converted value of the vertical G with the threshold line of the other vehicle models (standard cars, SUVs) in the determination map (during lift-off) DM1 (step S535). Furthermore, the management unit 12 updates the lift maps LM (lift map LM1 for a standard car, lift map LM2 for an SUV) for other vehicle models (standard cars, SUVs) based on the comparison result (step S537).

On the other hand, when it is determined that the information is not acquired during lift-off (step S531; No), the management unit 12 updates the sports car lift map LM3 based on the result of comparing the vertical G and vehicle speed included in the update information with the determination map (during lift-on) DM2 (step S539). A set of vertical G and vehicle speed included in the update information is mapped on a determination map (during lift-on) DM2 as shown in FIG. 13, and it is determined whether or not the magnitude recommends lift-up based on the positional relationship with the sports car threshold line TL3. When the mapped point is located below the sports car threshold line TL3 in the vertical G-axis direction, it is determined that the magnitude does not recommend lift-up (lift-up is not required). In this case, the vehicle position corresponding to this point is not registered as a lift recommendation point. On the other hand, when the mapped point is located above the sports car threshold line TL3 in the vertical G-axis direction, it is determined that the magnitude recommends lift-up (lift-up is required). In this case, the vehicle position corresponding to this point is registered as a lift recommendation point.

Next, the management unit 12 uses the update information provided from the vehicle M, which is a sports car, to update the lift map LM corresponding to other vehicle models. For example, the management unit 12 converts the data of the vertical G detected in the sports car into data of the vertical G corresponding to other vehicle models (standard cars, SUVs) by multiplying the vertical G included in the update information provided from the vehicle M, which is a sports car, by a predetermined coefficient, and compares the changed value of the vertical G with the threshold line of the other vehicle models (standard cars, SUVs) in the determination map (during lift-on) DM2 (step S541). Further, the management unit 12 updates the lift maps LM (standard car lift map LM1, SUV lift map LM2) of other vehicle models (standard cars, SUVs) based on the comparison result (step S537).

On the other hand, when it is determined that the update information is not additional information of the lift recommendation point (step S501; No), the management unit 12 performs a deletion update process of the lift recommendation point (step S543). The process of deleting and updating the lift recommendation point will be described in detail later. As described above, the process of the flowchart ends.

### Process of Deleting and Changing Lift Recommendation Point

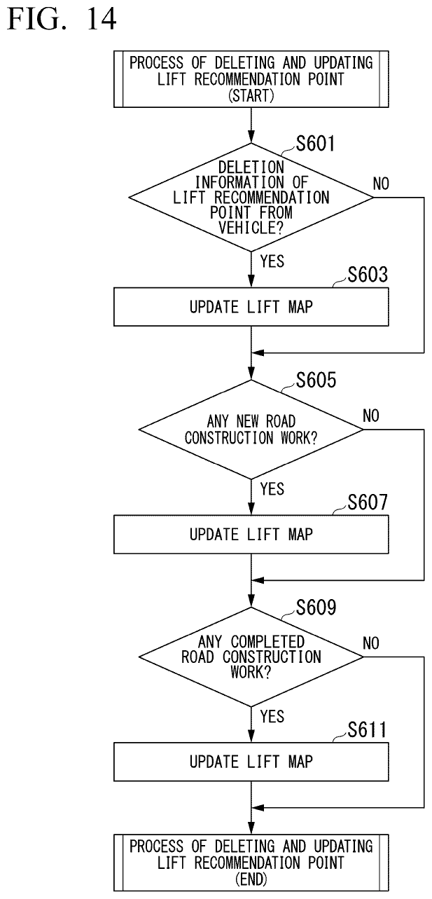

Next, the details of the process of deleting and updating the lift recommendation point in step S543 will be described. FIG. 14 is a flowchart illustrating an example of a flow of a process of deleting and updating the lift recommendation point by the automatic lift-up management device 1 according to the embodiment.

First, the management unit 12 determines whether or not the update information received from each vehicle M is deletion information requesting deletion of the lift recommendation point (step S601). When it is determined that the information is for deleting the lift recommendation point (step S601; Yes), the management unit 12 updates the lift map LM stored in the storage unit 30 (step S603). For example, the management unit 12 deletes the lift recommendation points included in the update information from the lift map LM corresponding to the vehicle model of the vehicle M that is the source of the update information.

Next, the management unit 12 determines whether or not there is any new road construction work that has started based on the road construction information acquired by the acquisition unit 11 (step S605). When it is determined that new road construction has started (step S605; Yes), the management unit 12 registers the point corresponding to this road construction as a lift recommendation point in the lift map LM and updates the lift map LM (step S607).

Next, the management unit 12 determines whether or not any road construction work has been completed based on the road construction information acquired by the acquisition unit 11 (step S609). When it is determined that there is a completed road construction (step S609; Yes), the management unit 12 deletes the lift recommendation point corresponding to this road construction from the lift map LM and updates the lift map LM (step S611). As described above, the process of the flowchart ends.

According to the above-described embodiment, it is possible to expand the range in which the vehicle lift-up control can be automated.

Although the mode for carrying out the present invention has been described using an embodiment, the present invention is not limited to such an embodiment, and various modifications and substitutions can be made within the scope that does not deviate from the gist of the present invention.

What is claimed is:

1. An automatic lift-up control device comprising:
an acquisition unit which acquires position information indicating a position of a target vehicle and lift-up recommendation point information having a registered recommendation point for recommending lift-up based on information provided from a plurality of vehicles;
a determination unit which determines whether or not the position of the target vehicle corresponds to the recommendation point registered in the lift-up recommendation point information; and
a lift-up control unit which lifts up the target vehicle when it is determined that the position of the target vehicle corresponds to the recommendation point registered in the lift-up recommendation point information.

2. The automatic lift-up control device according to claim 1, further comprising:
an update control unit which generates update information of the lift-up recommendation point information based on at least one of an instruction for a lift operation by an occupant of the target vehicle and a vehicle state of the target vehicle.

3. The automatic lift-up control device according to claim 2,
wherein the update control unit determines a point in which an index value related to the movement of the target vehicle in a height direction included in the vehicle state of the target vehicle exceeds a predetermined threshold value as a recommendation point to be added, and generates the update information including information on the determined recommendation point to be added.

4. The automatic lift-up control device according to claim 2,
wherein the update control unit determines a point in which an instruction to avoid lift-up has been input by the occupant among the recommendation points registered in the lift-up recommendation point information as a recommendation point to be deleted from the lift-up recommendation point information, and generates the update information including information on the determined recommendation point to be deleted.

5. The automatic lift-up control device according to claim 2,
wherein the update control unit determines a point in which an index value related to the movement of the target vehicle in a height direction included in the vehicle state of the target vehicle is equal to or lower than a threshold value among the recommendation points registered in the lift-up recommendation point information as a recommendation point to be deleted from the lift-up recommendation point information, and generates the update information including information on the determined recommendation point to be deleted.

6. The automatic lift-up control device according to claim 1,
wherein the acquisition unit acquires the lift-up recommendation point information corresponding to a vehicle model of the target vehicle.

7. The automatic lift-up control device according to claim 1, further comprising:
a display control unit which causes a display device to display a screen for receiving an instruction to add a recommendation point to the lift-up recommendation point information and to delete the recommendation point registered in the lift-up recommendation point information.

8. The automatic lift-up control device according to claim 1,
wherein when it is determined that the position of the target vehicle does not correspond to the recommendation point registered in the lift-up recommendation point information, the lift-up control unit lifts up the target vehicle in response to the vehicle state of the target vehicle.

9. The automatic lift-up control device according to claim 3,
wherein the index value includes at least one of acceleration and suspension stroke.

10. An automatic lift-up management device comprising:
an acquisition unit which acquires information on a recommendation point for recommending lift-up from a plurality of vehicles;
a management unit which aggregates information on the recommendation point and generates lift-up recommendation point information; and
a provision unit which provides the lift-up recommendation point information to each of the plurality of vehicles.

11. The automatic lift-up management device according to claim 10,
wherein the management unit updates the lift-up recommendation point information based on information on a road provided from an external device.

12. An automatic lift-up control system comprising:
the automatic lift-up control device according to claim 1; and
an automatic lift-up management device comprising:
an acquisition unit which acquires information on a recommendation point for recommending lift-up from a plurality of vehicles;
a management unit which aggregates information on the recommendation point and generates lift-up recommendation point information; and
a provision unit which provides the lift-up recommendation point information to each of the plurality of vehicles.

13. An automatic lift-up control method of causing a computer of an automatic lift-up control device to:
acquire position information indicating a position of a target vehicle and lift-up recommendation point information having a registered recommendation point for recommending lift-up based on information provided from a plurality of vehicles;
determine whether or not the position of the target vehicle corresponds to the recommendation point registered in the lift-up recommendation point information; and
lift up the target vehicle when it is determined that the position of the target vehicle corresponds to the recommendation point registered in the lift-up recommendation point information.

14. An automatic lift-up management method of causing a computer of an automatic lift-up management device to:
acquire information on a recommendation point for recommending lift-up from a plurality of vehicles;
aggregate information on the recommendation point and generate lift-up recommendation point information; and
provide the lift-up recommendation point information to each of the plurality of vehicles.

15. A computer-readable non-transitory storage medium for storing a program causing a computer of an automatic lift-up control device to:
acquire position information indicating a position of a target vehicle and lift-up recommendation point information having a registered recommendation point for recommending lift-up based on information provided from a plurality of vehicles;
determine whether or not the position of the target vehicle corresponds to the recommendation point registered in the lift-up recommendation point information; and
lift up the target vehicle when it is determined that the position of the target vehicle corresponds to the recommendation point registered in the lift-up recommendation point information.

16. A computer-readable non-transitory storage medium for storing a program causing a computer of an automatic lift-up control device to:
acquire information on a recommendation point for recommending lift-up from a plurality of vehicles;
aggregate information on the recommendation point and generate lift-up recommendation point information; and
provide the lift-up recommendation point information to each of the plurality of vehicles.
